(19) United States
(12) Patent Application Publication
(10) Pub. No.: US 2014/0278768 A1
(43) Pub. Date: Sep. 18, 2014

(54) METHODS, SYSTEMS AND APPARATUS TO SELECT STORE SITES

(71) Applicant: Michael J. Zenor, Deerfield, IL (US)

(72) Inventor: Michael J. Zenor, Deerfield, IL (US)

(21) Appl. No.: 13/795,464

(22) Filed: Mar. 12, 2013

(51) Int. Cl. G06Q 30/02

(52) U.S. Cl. CPC G06Q 30/0202
USPC 705/7.31

(57) ABSTRACT

Methods and apparatus are disclosed to select retail store sites. An example method includes generating a list of first descriptor types associated with a plurality of existing store locations, calculating, with a processor, a set of analog principal components factors (PCFs) for corresponding ones of the plurality of existing store locations, calculating a set of candidate PCFs for corresponding ones of a plurality of candidate locations, calculating respective similarity values based on the PCFs associated with respective pairs of the plurality of existing store locations and the plurality of candidate locations, for corresponding ones of the plurality of candidate locations, calculating a sum of second descriptor types associated with the existing store locations based on the respective similarity value, and predicting the performance of the candidate store locations based on a ratio of a sum of second descriptor types and a sum of the similarity values for the corresponding existing store location.

### FIELD OF THE DISCLOSURE

This disclosure relates generally to market research, and, more particularly, to methods, systems and apparatus to select store sites.

### BACKGROUND

In recent years, the experiences of store planners, such as real estate personnel and/or corporate planners, decide where to build new stores (e.g., retail establishments, shopping clubs, wholesalers, etc.). In the event a merchant, such as a retail chain, desires to build a new store in a city, then a number of candidate site locations are considered by the planner. Some decision criteria considered by the planner include proximity to competitors, proximity to other stores, and/or proximity to major roadways.

Despite the one or more decision criteria considered by the planner when selecting a candidate site location on which to build a new commercial establishment, such selections are based on subjective opinions of the planner. Some stores require investments in excess of $50 million to purchase the candidate site location, complete building construction and stock the new establishment with merchandise. In the event the planner fails to select the correct site, then substantial amounts of capital investment may be wasted.

### BRIEF DESCRIPTION OF THE DRAWINGS

FIG. 1 is a schematic illustration of an example system constructed in accordance with the teachings of this disclosure to select store sites.

FIGS. 2, 5, 7 and 9 are flowcharts representative of example machine readable instructions which may be executed to implement the example system of FIG. 1 to select store sites.

FIGS. 3A, 3B and 3C are tables illustrating example client store data generated by the system of FIG. 1.

FIG. 4 is a table illustrating example candidate store data generated by the system of FIG. 1.

FIG. 6 is a table of example similarity calculations between client stores and candidate stores performed by the system of FIG. 1.

FIGS. 8A and 8B are tables illustrating example predictions of performance for candidate stores performed by the system of FIG. 1.

FIG. 10 is a schematic illustration of an example processor platform that may execute the instructions of FIGS. 2, 5, 7 and 9 to implement the example systems and apparatus of FIG. 1.

### DETAILED DESCRIPTION

Merchants invest substantial amounts of time and money into deciding where to build a new physical (e.g., brick and mortar) store. After a candidate city or region of interest is identified in which to build the new store, planners employed by the merchant generate a list of candidate locations that may be for sale, lease, etc. The list of candidate locations may be selected by the planners based on any number of criteria and/or descriptor types including, but not limited to price, proximity to competitors, proximity to other stores that might drive customer traffic, proximity to major roadways and/or locations unencumbered with political barriers (e.g., excessive taxes, union demands, municipal permit challenges, municipal enticements, etc.). Evaluating these one or more criteria may involve numerous site visits to gather data and/or other observations associated with the candidate locations.

After generating a list having any number of candidate locations, the planner(s) consider the criteria and/or collected observations to make the final selection for the new store location. In some examples, the planner(s) have carte blanche authority to make the selection, while in other examples the planner(s) present a narrowed-down subset of candidate locations to one or more corporate decision makers. While the ultimate decision for the store location may consider a relatively detailed number of criteria indicative of potential market success, the decision making process is neither entirely objective nor repeatable. In other words, alternate personnel chartered with the responsibility of the planner(s) may select different store locations when presented with the same criteria and/or observations.

Relying upon planner discretion may also introduce substantial time delay, particularly when faced with a geographic market of interest in which commercial property sells or leases relatively quickly. In the event the planner identifies, for example, fifty candidate locations in a city, then the visiting of each location may consume too much time before one or more of those candidate locations is sold or leased to another entity. Additionally, the aforementioned time constraint is compounded in the event the planner is associated with a large entity (e.g., a retailer that operates nationally) that desires to simultaneously build stores in multiple cities during the same time period. For example, some companies (e.g., Wal-Mart) target 20-30 new stores in the nation per year.

Example methods, apparatus, systems and/or articles of manufacture disclosed herein employ one or more similarity functions with existing physical stores (sometimes referred to herein as “analogs”) to identify which existing stores are the most similar to a candidate site. Descriptor types associated with the most similar existing stores are imputed to each candidate location to reveal one or more candidate locations indicative of the highest potential success as indicated by a set of outcome variables. Descriptor types related to some such outcome variables and/or metrics may include, for example, annual sales per time period (e.g., dollar sales per year), gross profit per time period, net profit per time period, etc. Additionally, prediction accuracy may be improved by calibrating principal components factors with one or more weights by generating outcome data predictions with a known/existing store (sometimes referred to herein as a “placeholder store”) location and reducing (e.g., minimizing) the difference between the outcome prediction and the empirical outcome data associated with the known/existing store.

FIG. 1 illustrates an example system 100 to select store sites. In the illustrated example of FIG. 1, the system 100 includes a site evaluator 102 communicatively connected to a client store descriptor database 104, a demographics information database 106 and a physical characteristics database 108. The example client store descriptor database 104 includes information associated with descriptor types related to outcome performance of existing comparable stores, such as sales per time period, gross profit per time period, net profit per time period, etc. In some examples, the client store descriptor database 104 contains performance data collected by the client for any number of client stores already operating in a market on a local, regional, national and/or multi-national scale.

The example demographics information database 106 of FIG. 1 includes descriptor types related to demographics information associated with any number of geographic locations within a region, nation and/or global location. In some examples, the demographics information database 106 may be implemented via the Spectra™ database that is managed and maintained by The Nielsen Company. For instance, the Spectra™ database may identify consumer segmentation information associated with geographic locations, thereby allowing one or more planners to identify dominant demographic types within a trading area of interest (e.g., a likely sales influence (e.g., demand) associated with a site).

The example physical characteristics database 108 of FIG. 1 is communicatively connected to the example site evaluator 102. The example physical characteristics database 108 contains descriptor types related to physical store characteristics. In some examples, the physical characteristics database 108 is implemented by the TDLinx™ database/services managed and maintained by The Nielsen Company. The example TDLinx™ database includes data related to store size (e.g., square footage), number of store employees, number of store levels, presence of in-store features (e.g., pharmacy department, tobacco department, gas station, etc.), geographic latitude/longitude, channel types serviced by the store (e.g., grocery, liquor, etc.). As described in further detail below, the example site evaluator 102 of FIG. 1 uses physical characteristics as one type of metric when determining a degree of similarity to a candidate store location and one or more existing store locations.

In the illustrated example of FIG. 1, the site evaluator 102 includes a physical characteristics manager 110, a demographic characteristics manager 112, a principal components engine 114, a candidate store analyzer 116, a candidate store ranking engine 118, and a similarity engine 120. The example site evaluator 102 of FIG. 1 also includes an example calibration module 122, which includes an example prediction engine 124, an example seed placeholder engine 126, an example difference analyzer 128, an example weight assigner 130, and an example optimizing engine 132.

In operation, the example physical characteristics manager 110 assembles descriptor information associated with existing stores to identify store attributes (e.g., physical descriptors) and corresponding outcome data (e.g., outcome descriptors such as annual profit). For example, the physical characteristics manager 110 identifies each store in the example client store descriptor database 104 and, based on its physical location (e.g., address, latitude/longitude, Global Positioning Satellite (GPS) coordinates, etc.), references the example physical characteristics database 108 to associate one or more physical characteristics to each existing store. As described above, the example physical characteristics database may be the TDLinx™ database and/or information system managed by The Nielsen Company. The example client store descriptor database 104 of FIG. 1 may also include information related to outcome data of each corresponding store (e.g., the yearly sales, yearly profit, etc.).

The example demographics characteristics manager 112 of FIG. 1 associates existing stores with corresponding demographics and trading area information. For example, an existing client store location may have an effective sales influence within a four mile radius. Within that radius, the example demographics characteristics manager 112 identifies consumer segment type(s) that reside within the trading area. The different types of consumer segments that may be near each store location are some of the factors that may influence a degree of similarity between existing stores and/or candidate store locations under consideration for new construction.

Generally speaking, store characteristics that do not relate to financial performance and/or marketing objectives are referred to herein as non-outcome descriptors. Non-outcome descriptors (descriptor types) include, for example, store size, number of store employees, store location, proximity to competitors, etc. On the other hand, store characteristics that relate to financial performance and/or marketing objectives are referred to herein as outcome descriptors. Outcome descriptors include, for example, yearly profit, yearly sales, etc. Both non-outcome descriptors and outcome descriptors may include a relatively large number of variables (e.g., store size), each of which may include corresponding values (e.g., 10,000 sq. ft.). Needing to deal with and/or otherwise compute relatively large numbers of disparate variables when identifying similarities between stores increases mathematical complexity and a corresponding need for more computing resources.

The example principal components engine 114 of FIG. 1 identifies trends in a data set and reduces a number of variables with which to operate based on a principal components analysis. Principal components factors generated by the example principal components engine 114 of FIG. 1 are non-outcome descriptors that identify linear combinations of major trends that exist within the data set. The example principal components factors facilitate and/or otherwise enable a transformation of the data set into a reduced number of variables that are uncorrelated with each other, thereby simplifying one or more subsequent calculations with the non-outcome descriptors. Additionally, when the planner identifies one or more candidate locations on which to build a new store, the example candidate store analyzer 116 of FIG. 1 generates principal components factors associated with the new candidate location. For example, each candidate location under consideration for new store construction has an associated address and/or latitude/longitude value. From such geographic location information, a number of non-outcome descriptors may be identified such as, for example, proximity to competitors, proximity to other stores (e.g., retailers), proposed new store size, proposed number of employees at the new store, whether the new store will have an optical center, gas station, drug store, demographic influence/presence, etc.

The example similarity engine 120 of FIG. 1 computes a descriptive similarity between each candidate location and the existing stores (analogs). In particular, the example candidate store analyzer 116 selects a candidate location and its corresponding principal components factors. The example similarity engine 120 calculates a square of the difference between principal components factors of the selected candidate location and each analog. A dissimilarity value for each pair (i.e., the candidate location and each available analog) is calculated by the example similarity engine 120 in a manner consistent with example Equation 1:

$$DISSIM [ i , j ] = \sqrt{{\sum }_{k} {( {PC}_{ik} - {PC}_{jk} )}^{2}} . \qquad Equation 1$$

In example Equation 1, DISSIM[i,j] refers to a dissimilarity value between a candidate store i and an existing store j, in which PCᵢ refers to a principal components factor for the candidate store i and PCⱼ refers to a principal components factor for the existing store j. Additionally, in example Equation 1, k refers to one of any number of principal components factors that may exist for each candidate and/or existing store. For example, while one principal components factor may exist for each available outcome variable (e.g., size of store), some outcome variables may be correlatively duplicative and removed by way of one or more principal components analysis techniques. As described in further detail below, a weight for each principal components factor may be applied when calculating the dissimilarity value.

Based on the dissimilarity value between the candidate store and an analog store, a corresponding similarity value is calculated by the example similarity engine 120 of FIG. 1 based on Equation 2.

$$SIM [ i , j ] = {e}^{\frac{- DISSIM [ i , j ]}{2}} . \qquad Equation 2$$

In the illustrated example of Equation 2, SIM[i,j] refers to a similarity value between the candidate store and an existing analog. After the example similarity engine 120 calculates a similarity value for the candidate location and each available analog, the similarity engine 120 of the illustrated example determines whether one or more additional candidate locations are available for consideration. As described above, the planner(s) may identify any number of candidate locations within a city/region of interest in which a new store is to be built. Depending on the non-outcome variables associated with each candidate store location, different analogs will result as being more/less similar to each candidate store location. Additionally, because each candidate location may have different analogs deemed most similar, the planner has an opportunity to identify and/or otherwise rank the candidate locations in a manner that illustrates those having the highest/best outcome variables. In other words, some candidate locations may be more associated with analogs that have relatively higher performance values, such as gross sales per year. Predicted outcome variables associated with one or more new candidate locations may be determined in a manner consistent with example Equation 3:

$$Y [ n ] = \frac{{\sum }_{i} SIM [ i , n ] * {y}_{i}}{{\sum }_{i} SIM [ i , n ]} . \qquad Equation 3$$

In the illustrated example of Equation 3, i refers to an existing location, n refers to a new location (candidate location), yᵢ refers to an outcome variable at the i^{th} existing location, and Y[n] refers to the predicted outcome variable. For example, Equation 3 may yield a predicted outcome variable related to sales of soda traffic.

The example candidate store analyzer 116 of FIG. 1 identifies leading candidate locations that are being considered. For each candidate location, the example candidate store ranking engine 118 of FIG. 1 arranges the existing stores (analogs) in rank order based on respective similarities (non-outcome related principal components factors). Each analog has a corresponding similarity value (e.g., see example Equation 2). The example similarity engine 120 of FIG. 1 adds the sum of all analogs associated with the candidate store. Additionally, each similarity value for each analog is multiplied with the outcome variable of that analog to generate a weighted outcome value for the corresponding analog. The sum of weighted analog values is then divided, with the example prediction engine 124 of FIG. 1, by the sum of similarity values to derive a prediction associated with the candidate location. In the event one or more additional candidate locations exist for the region of interest (e.g., a city in which the planner is to select a location for new store construction), then the example candidate store analyzer 116 selects the new candidate location to derive another prediction. When all available candidate locations have been considered and corresponding predictions generated based on the weighted similarity values, the candidate store ranking engine 118 ranks each candidate location based on the prediction values to identify a leading candidate location.

In addition to considering one or more candidate locations, example methods, apparatus, systems, and/or articles of manufacture disclosed herein facilitate store layout analysis differences. In some examples, one candidate location may be evaluated in view of one or more different store layouts. Some example store layouts may include tobacco sales, pharmacy sales, gas station amenities, different building square footage, etc. Selected store layouts at each candidate location typically require a corresponding analog store having the same type of layout.

In some examples, prediction accuracy may be improved by calibrating the principal components factors associated with the analogs. Generally speaking, all of the available analogs have corresponding empirical outcome related data, such as annual sales figures (e.g., stored in the example client store descriptor database 104). Knowing what the actual outcome variable values are allows one or more predictions to be conducted under the assumption that the outcome variables are unknown for a particular analog. In the event there is a difference between the empirical outcome related data and the predicted outcome variables, then the principal components factors associated with the analog under test may be adjusted and/or otherwise calibrated to reduce (e.g., minimize) the difference.

When calibrating the principal components factors (and corresponding similarity values), the example seed placeholder engine 126 of FIG. 1 selects an existing placeholder store from the plurality of available analogs. As described above, even though actual/empirical outcome data is known for the placeholder store, one or more calibration weights to be applied to the corresponding principal components factors may be developed after identifying a difference between the prediction and the actual/empirical outcome data (e.g., annual profit). The example prediction engine 124 of FIG. 1 calculates a prediction for the placeholder store. The example difference analyzer 128 of FIG. 1 identifies a difference value between the prediction and the actual outcome data. The difference is saved for later analysis. In the event there are one or more additional and/or alternate existing stores to be treated as a placeholder store, then the example seed placeholder engine 126 of FIG. 1 repeats the prediction for such one or more additional and/or alternate analogs.

When difference values are obtained for one or more analogs, then the weight assigner 130 of FIG. 1 assigns each principal components factor for each analog with a beginning calibration variable having a unity weight value (e.g., 1). Generally speaking, a unity weight value produces no weighting influence on one or more similarity calculations performed (e.g., see example Equations 1 and 2), but the unity weight value serves as a suitable starting point in the calibration process. The example optimizing engine 132 solves the calibration values to reduce (e.g., minimize) and/or otherwise improve the accuracy of the previously saved differences between actual outcome data and predicted outcome data for each analog. The calibration values may then be used by the principal components engine 114 to adjust principal components factor values for each analog before re-calculating similarity values for each store pair. In some examples, a weighting value may be applied in a manner consistent with example Equation 4.

$$DISSIM [ i , j ] = \sqrt{{\sum }_{k} {{w}_{k} ( {PC}_{ik} - {PC}_{jk} )}^{2}} \\ DISSIMi , = kwk ( PCik - PCjk ) . \qquad Equation 4$$

In the illustrated example of Equation 4, wₖ is a weighting value associated with the k^{th} principal components factor. In some examples, one or more factors may exhibit differences when compared to other candidate locations, but may not result in an appreciable effect on a measurable outcome variable. As such, some factors may be weighted relatively lower.

While an example manner of implementing an example system 100 to select store sites has been illustrated in FIG. 1, one or more of the elements, processes and/or devices illustrated in FIG. 1 may be combined, divided, re-arranged, omitted, eliminated and/or implemented in other ways. Further, the example site evaluator 102, the example client store descriptor database 104, the example demographics information database 106, the example physical characteristics database 108, the example physical characteristics manager 110, the example demographic characteristics manager 112, the example principal components engine 114, the example candidate store analyzer 116, the example candidate store ranking engine 118, the example similarity engine 120, the example calibration module 122, the example prediction engine 124, the example seed placeholder engine 126, the example difference analyzer 128, the example weight assigner 130, and/or the example optimizing engine 132 of FIG. 1 may be implemented by hardware, software, firmware and/or any combination of hardware, software and/or firmware. Thus, for example, any of the example site evaluator 102, the example client store descriptor database 104, the example demographics information database 106, the example physical characteristics database 108, the example physical characteristics manager 110, the example demographic characteristics manager 112, the example principal components engine 114, the example candidate store analyzer 116, the example candidate store ranking engine 118, the example similarity engine 120, the example calibration module 122, the example prediction engine 124, the example seed placeholder engine 126, the example difference analyzer 128, the example weight assigner 130 and/or the example optimizing engine 132 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example site evaluator 102, the example client store descriptor database 104, the example demographics information database 106, the example physical characteristics database 108, the example physical characteristics manager 110, the example demographic characteristics manager 112, the example principal components engine 114, the example candidate store analyzer 116, the example candidate store ranking engine 118, the example similarity engine 120, the example calibration module 122, the example prediction engine 124, the example seed placeholder engine 126, the example difference analyzer 128, the example weight assigner 130 and/or the example optimizing engine 132 of FIG. 1 is hereby expressly defined to include a tangible computer readable storage device or storage disk such as a memory, DVD, CD, Blu-ray, etc. storing the software and/or firmware. Further still, the example system 100 of FIG. 1 may include one or more elements, processes and/or devices in addition to, or instead of, those illustrated in FIG. 1 and/or may include more than one of any or all of the illustrated elements, processes and devices.

Flowcharts representative of example machine readable instructions for implementing the system 100 of FIG. 1 are shown in FIGS. 2, 5, 7 and 9. In this example, the machine readable instructions comprise a program for execution by a processor such as the processor 1012 shown in the example processor platform 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 2, 5, 7 and 9, many other methods of implementing the example system 100 to select store sites may alternatively be used. For example, the order of execution of the blocks may be changed, and/or some of the blocks described may be changed, eliminated, or combined.

As mentioned above, the example processes of FIGS. 2, 5, 7 and 9 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage device and/or storage disk and to exclude propagating signals. Additionally or alternatively, the example processes of FIGS. 2, 5, 7 and 9 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 200 of FIG. 2 begins at block 202 where the example physical characteristics manager 110 assembles existing store data to identify corresponding store attributes (e.g., non-outcome descriptors) and corresponding outcome data (e.g., annual sales figures). In some examples, the client store descriptor database 104 is managed by a client having any number of stores throughout the region of interest (e.g., a nation). In the event the client does not have one or more types of non-outcome variables associated with each of their store locations, the example physical characteristics manager 110 merges physical characteristics information using the example physical characteristics database 108 with the client store information.

FIG. 3A is an example table 300 that merges client store data with physical characteristics information. In the illustrated example of FIG. 3A, the client data 302 includes store numbers 304 and corresponding store names 306. While the client may also include information corresponding to outcome associated with each store location, such as annual performance metrics (e.g., annual sales, annual profit, etc.), the client may not have details corresponding to physical characteristics for each location. The example physical characteristics manager 110 accesses the example physical characteristics database 108 to identify one or more non-outcome variables that can be associated with one or more client stores. As described above, the example physical characteristics database 108 may include information and/or services obtained from the TDLinx service, which collects store information for one or more regions of interest. In the illustrated example of FIG. 3A, the physical characteristics manager 110 identifies corresponding non-outcome data 308 associated with each client location. The example non-outcome data 308 identified by the example physical characteristics manager 110 from one or more searches/queries to the example physical characteristics database 108 includes city information 310, total square footage of the store 312, whether the store includes a fuel club 314, whether the store includes a tobacco club 316 and whether the store includes a pharmacy 318. The example city information 310 may include any type of location detail such as, for example, address information and/or latitude/longitude coordinate information. While the illustrated example of FIG. 3A includes five (5) example physical characteristics, such examples are provided for illustration and not limitation. Any number of additional and/or alternate physical characteristics may be employed in the client data 302.

Returning to the illustrated example of FIG. 2, the example demographics characteristics manager 112 associates the existing store locations with corresponding demography and trading area data (block 204). While client data 302 may include details related to outcome, the client data 302 may not have information associated with relevant demographics associated with the trading area of each location. The example demographics characteristics manager 112 accesses one or more sources of demographics information, such as the example demographics information database 106, to associate the client data 302 with relevant demographics information.

FIG. 3B builds upon the example table 300 of FIG. 3A described above. In the illustrated example of FIG. 3B, the demographics characteristics manager 112 searches the example demographics information database 106 for demographics information 330 associated with the client data 302. In some examples, the demographics information database 106 includes data and/or services from the Spectra™ service and identifies one or more demographic segments proximate each store. The example demographics information 330 identified by the example demographics characteristics manager 112 that is relevant to the example client data 302 includes a percentage of Asian households 332, a percentage of European households 334, a percentage of Hispanic households 336, a percentage of households earning more than $75,000 per year 338 and a percentage of households where the head-of-household (HOH) age is greater than forty-five 340. While the illustrated example of FIG. 3B includes five (5) example demographic characteristics, any number of additional and/or alternate demographic characteristics may be employed as the client data 302.

To reduce (e.g., minimize) the quantity of variables to be used when predicting performance related data associated with one or more candidate store locations, the example principal components engine 114 generates principal components factors for each existing store location (analogs) using non-outcome descriptors (block 206). As described above, principal components analysis on a data set reduces a relatively large number of data variables into a smaller number of data variables, in which the reduced number of data variables (i.e., the principal component variables) are uncorrelated with each other. FIG. 3C builds upon the example table 300 of FIGS. 3A and 3B described above. In the illustrated example of FIG. 3C, the principal components engine 114 generates principal components factors 350 for each store 304 based on the non-outcome data 308. While the illustrated example of FIG. 3C includes eight (8) example principal components factors, any number and/or types of additional and/or alternate factor(s) may be used.

Returning to the illustrated example of FIG. 2, the example candidate store analyzer 116 retrieves one or more candidate store locations under consideration for new store placement (block 208). As described above, any number of candidate sites may be considered within a geography of interest (e.g., a city). Although the candidate sites are not yet constructed and/or otherwise ready for sales operations, one or more non-outcome descriptors can be associated with each candidate site. For example, the exact address and/or latitude/longitude location coordinates for each candidate site can be determined, and one or more intended/planned physical characteristics associated with the candidate site can be determined. In some examples, the approximate store size (e.g., square footage) is known ahead of time, the presence of a pharmacy in the future store can be known ahead of time, and/or the number of employees to work at the future store can be known ahead of time. Regardless of the eventual location for the new store, one or more of the aforementioned physical characteristics can be known ahead of time and may be identical to one or more other candidate sites.

On the other hand, other physical characteristics (non-outcome variables) associated with each candidate store may be unique from one candidate site to the next. For example, because each candidate site includes a unique geographic location (e.g., a unique address, a unique latitude/longitude combination), one or more differing features may or may not exist near the candidate site. Some candidate sites may have a relatively closer proximity to a major competitor of a client, other candidate sites may be relatively nearer or farther away from major roadways, while still other candidate sites may be relatively nearer or farther away from shopping centers. Using such non-outcome variables that can be determined for each candidate site, the example principal components engine 114 generates principal components factors for each candidate store location (block 210).

FIG. 4 is an example table 400 that associates each candidate store 402 with non-outcome data 404 and corresponding demographics data 406 in a manner similar to that shown in FIGS. 3A-3C. In the illustrated example of FIG. 4, seven (7) candidate store sites 402 are under consideration for future construction (store numbers 6610 through 6616). Corresponding principal components factors 408 for each of the candidate stores 402 are generated and/or otherwise calculated by the example principal components engine 114. While only eight (8) principal components factors 408 are shown for each candidate store site, any number of additional and/or alternative factors may be employed.

Returning to FIG. 2, and as described in further detail below, a degree of similarity (e.g., a similarity value) is determined by the example similarity engine 120 for each candidate store and existing store pair using the associated principal components factors (block 212). Leading candidate sites/locations are determined by the example candidate store ranking engine 118 based on calculated similarity values and weighted outcome variables (block 214). In some examples, the calibration module 122 generates one or more weighting values for the principal components factors for each existing store (block 216), such as the example principal components factors 350 in the illustrated example of FIG. 3C. As described in further detail below, some factors may be more or less relevant than other factors. By generating predictions with existing stores, difference values between the predictions and empirical outcome data can be calculated and used to generate calibration weights for the principal components factors 350.

FIG. 5 illustrates block 212 from FIG. 2 in greater detail. In the illustrated example of FIG. 5, the example candidate store analyzer 116 selects a candidate location and its corresponding principal components factors (block 502). The example similarity engine 120 calculates the square of the difference between principal components factors for the candidate location and the principal components factors for one of the existing stores (block 504). A dissimilarity value associated with the candidate location and the selected existing store is calculated by the example similarity engine 120 (block 506) in a manner consistent with example Equation 1. Additionally, the example similarity engine 120 calculates a corresponding similarity value based on the dissimilarity value for the pair (block 508) in a manner consistent with example Equation 2.

Turning briefly to FIG. 6, an example table 600 showing calculation of the dissimilarity value 602 and the similarity value 604 between a candidate site 606 and an existing store 608 is shown. In the illustrated example of FIG. 6, principal components factors 610 associated with the candidate store 606 and principal components factors 612 associated with the existing store 608 are applied to example Equation 1 to generate dissimilarity values 614 associated with each factor. The sum of the example dissimilarity values 602 are applied to example Equation 2 to generate a similarity value 604 associated with the candidate/existing store pair (606/608).

Returning to FIG. 5, in the event the example calibration module 122 identifies any associated calibration weights for the example existing store (block 510), then such weights are applied to the example principal components factors 612 associated with the existing store 608 (block 512) and the similarity value is recalculated. On the other hand, if there are no calibration weights for the example existing store (block 510) or the similarity value has been recalculated in view of applied calibration weights (block 512), then the example candidate store analyzer 116 determines whether additional store pairs are to be analyzed to derive similarity values (block 514). If so, then control returns to block 502. For example, if an example city of interest includes two candidate locations and the client has twenty existing stores throughout the nation, then the set of principal components factors associated with each candidate location will be analyzed in view of each of the twenty existing stores to generate a similarity value for the pair. In view of the example scenario, a total of forty (40) similarity values will be generated.

FIG. 7 illustrates block 214 from FIG. 2 in greater detail. In the illustrated example of FIG. 7, the example candidate store analyzer 116 selects one of the candidate locations (block 702) and arranges the existing stores in a rank order based on the calculated similarity value (block 704). Each existing store will have an associated similarity score, which is summed by the example similarity engine 120 for all available existing stores (analogs) (block 706). Additionally, each existing store will have an associated outcome variable, such as a value of annual sales, for which the example similarity engine 120 multiplies by the similarity value to create a weighted outcome value (block 708). The sum of all weighted outcome values is calculated by the example similarity engine 120 (block 710) and the example prediction engine 124 divides this sum by the sum of similarity scores to generate a forecast for the candidate store location (block 712). However, because more than one candidate store location may be under consideration prior to construction, the example candidate store analyzer 116 returns control to block 702 to generate additional forecasts in view of the other candidate store locations, if any (block 714). When all candidate locations have been evaluated to reveal outcome variable forecast values (block 714), the example candidate store ranking engine 118 ranks each candidate location based on the resulting forecast values to identify a leading candidate (block 716).

FIG. 8A includes an example table 800 showing a comparison between candidate store number 6610 for the example candidate store location named “Big Box” in Delafield, Wis. 802. As a result of similarity calculations described above, the example table 800 includes a rank order of all available existing stores, which includes an existing store number 804, an existing store location 806, an existing store similarity score 808 in view of the candidate store of interest 802, an empirical outcome variable value 810 (e.g., prior year sales), and a weighted outcome variable value 812. In the illustrated example of FIG. 8A, an existing store in Schaumburg, Ill. is associated with the highest relative similarity score to the candidate store in Delafield, Wis. (i.e., similarity score value 0.64944). While the prior year sales for the Schaumburg store was over $53 million, a corresponding weighted prior year sales value is slightly over $34 million after applying the similarity score as a weight. In some examples, one or more existing stores may have a corresponding similarity weight of zero, thereby resulting in a zero value for the weighted sales value 812. The example table 800 includes all available existing stores in an order of decreasing similarity to the candidate store under consideration. In other words, the existing store in Schaumburg is most similar to the candidate store location in Delafield, while the existing store in Portland, Oreg. is the least similar to the candidate store location in Delafield.

The example prediction engine 124 calculates an outcome prediction or expected performance of the candidate store based on a ratio of weighted sales and similarity score values. In the illustrated example of FIG. 8A, the ratio of the sum of weighted sales 814 and the sum of similarity values 816 for all of the existing stores 804 results in a prediction of market performance 818.

The example table 800 illustrates a prediction or forecast 818 of approximately $76 million in annual sales if a new store is built on the candidate store location in Delafield. FIG. 8B illustrates an example table 850 in view of another candidate store location. In the illustrated example of FIG. 8B, the example table 850 shows a comparison between candidate store number 6611 in Mukwonago, Wis. (852), which is proximate to the previously discussed candidate location in Delafield, as described in connection with FIG. 8A. As a result of similarity calculations, the example table 850 includes a rank order of all available existing stores. In the illustrated example of FIG. 8B, an existing store in Portland, Oreg. (854) is associated with the highest relative similarity score to the candidate store in Mukwonago (i.e., similarity score value 0.5819) 852. In this example, the forecast suggests sales will be over $97 million (856) in the event the new store is constructed on the candidate site location in Mukwonago, Wis. While FIGS. 8A and 8B illustrate two example candidate locations and corresponding forecasts for outcome variables, example methods, systems, apparatus and/or articles of manufacture disclosed herein are not limited thereto. When all available candidate store sites have been considered and corresponding forecasts have been calculated, the example candidate store ranking engine 118 places the results in rank order to determine the new store construction site that generates a desired (e.g., maximum) outcome variable value (see block 716 of FIG. 7).

In some examples, the principal components factors associated with the existing stores may be calibrated to improve forecast accuracy. The example principal components factors of FIG. 3C (i.e., Factor 1 through Factor 8) do not include any weighed multiplier. As such, the influence of each particular principal component factor applies with equal magnitude to any other principal component factor. However, in some circumstances one or more of the principal components factors may have greater or lesser influence on a dataset. For example, if a first factor substantially relates to households having a red door, while a second factor substantially relates to households having a median income greater than $75,000, then the first factor exhibits a difference without a distinction and can be afforded a lesser weight on predictions.

FIG. 9 illustrates block 216 from FIG. 2 in greater detail. In the illustrated example of FIG. 9, the example seed placeholder engine 126 selects an existing store from the plurality of existing stores to serve as a placeholder store (block 902). Generally speaking, the selected placeholder store is treated like a candidate site location, despite the fact that outcome variable data is known for the placeholder store. In other words, empirical outcome data (e.g., annual sales) is known for the placeholder store so that a difference can be calculated after performing a prediction with the placeholder store using the associated principal components factors. The example prediction engine 124 calculates a prediction for the placeholder store in a manner consistent with FIG. 7 (block 904). The example difference analyzer 128 identifies a difference value between the predicted outcome value and the empirical outcome value (block 906). The calculated difference value is saved for later comparison (block 908). The example seed placeholder engine 126 determines whether there are additional existing stores available to be used as placeholder stores (block 910). If so, then control advances to block 902, otherwise the example weight analyzer 130 assigns each principal components factor for each placeholder store with an initial calibration weight of unity (block 912).

To reduce (e.g., minimize) and/or otherwise optimize a difference between outcome variable values of placeholder stores and their counterpart existing store outcome variable values, the example optimizing engine 132 of the illustrated example processes the calibration weight values associated with each principal components factor for each placeholder store using a minimizing technique (block 914). Example minimizing techniques to derive calibration weight values that minimize the outcome variable value differences include, for example, simulated annealing, genetic algorithms, hill climbing and/or regression. The example principal components engine 114 applies the calibration weights to each principal components factor for each of the existing stores (block 916), and updates corresponding dissimilarity values for each store pair in a manner consistent with example Equation 1 (block 918). Corresponding similarity values are updated and recalculated by the similarity engine 120 in a manner consistent with example Equation 2, thereby allowing future predictions to predict outcome values with greater fidelity (block 920).

FIG. 10 is a block diagram of an example processor platform 1000 capable of executing the instructions of FIGS. 2, 5, 7 and 9 to implement the system 100 of FIG. 1. The processor platform 1000 can be, for example, a server, a personal computer, an Internet appliance, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache) and is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 also includes an interface circuit 1020. The interface circuit 1020 may be implemented by any type of interface standard, such as an Ethernet interface, a universal serial bus (USB), and/or a PCI express interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, isopoint and/or a voice recognition system.

One or more output devices 1024 are also connected to the interface circuit 1020. The output devices 1024 can be implemented, for example, by display devices (e.g., a liquid crystal display, a cathode ray tube display (CRT), a printer and/or speakers). The interface circuit 1020, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The processor platform 1000 also includes one or more mass storage devices 1028 for storing software and data. Examples of such mass storage devices 1028 include floppy disk drives, hard drive disks, compact disk drives and digital versatile disk (DVD) drives.

The coded instructions 1032 of FIGS. 2, 5, 7 and 9 may be stored in the mass storage device 1028, in the volatile memory 1014, in the non-volatile memory 1016, and/or on a removable storage medium such as a CD or DVD.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to predict store performance, comprising:
generating a list of first descriptor types associated with a plurality of existing store locations;
calculating, with a processor, a set of analog principal components factors (PCFs) for corresponding ones of the plurality of existing store locations;
calculating a set of candidate PCFs for corresponding ones of a plurality of candidate locations;
calculating respective similarity values based on the PCFs associated with respective pairs of the plurality of existing store locations and the plurality of candidate locations;
for corresponding ones of the plurality of candidate locations, calculating a sum of second descriptor types associated with the existing store locations based on the respective similarity value; and
predicting the performance of the candidate store locations based on a ratio of a sum of second descriptor types and a sum of the similarity values for the corresponding existing store location.

2. A method as defined in claim 1, wherein the first descriptor types comprise physical characteristics associated with the plurality of existing store locations.

3. A method as defined in claim 2, wherein the physical characteristics comprise at least one of a store size, a number of employees, a proximity to competitors or a geographic location.

4. A method as defined in claim 1, wherein the second descriptor types comprise performance metrics associated with the plurality of existing store locations.

5. A method as defined in claim 4, wherein the performance metrics comprise at least one of annual dollar sales, annual profit or annual unit sales.

6. A method as defined in claim 1, wherein the sum of second descriptor types comprise a sum of weighted performance metrics.

7. A method as defined in claim 1, wherein calculating the sum of second descriptor types further comprises multiplying the similarity values by respective performance metrics to generate weighted performance metrics.

8. A method as defined in claim 1, further comprising substituting one of the plurality of existing store locations for a candidate location to generate a prediction of the performance of the candidate location.

9. A method as defined in claim 8, further comprising calculating a performance difference value between corresponding ones of the predicted performance of respective ones of the existing store locations and corresponding ones of empirical performance associated with the plurality of existing store locations.

10. A method as defined in claim 9, further comprising solving the set of PCFs with calibration weights to minimize the difference values.

11. An apparatus to predict store performance, comprising:
a physical characteristics manager to generate a list of first descriptor types associated with a plurality of existing store locations;
a principal components engine to:
calculate a set of analog principal components factors (PCFs) for corresponding ones of the plurality of existing store locations; and
calculate a set of candidate PCFs for corresponding ones of a plurality of candidate locations;
a similarity engine to calculate respective similarity values based on the PCFs associated with respective pairs of the plurality of existing store locations and the plurality of candidate locations; and
a prediction engine to:
for corresponding ones of the plurality of candidate locations, calculate a sum of second descriptor types associated with the existing store locations based on the respective similarity value; and
predict the performance of the candidate store locations based on a ratio of a sum of second descriptor types and a sum of the similarity values for the corresponding existing store location.

12. An apparatus as defined in claim 11, wherein the physical characteristics manager is to associate the first descriptor types with the plurality of existing store locations.

13. An apparatus as defined in claim 12, wherein the physical characteristics manager is to identify at least one of a store size, a number of employees, a proximity to competitors or a geographic location.

14. An apparatus as defined in claim 11, wherein the physical characteristics manager is to associate the plurality of existing store locations with the second descriptor types.

15. An apparatus as defined in claim 11, further comprising a weight analyzer to multiply the similarity values by respective performance metrics to generate weighted performance metrics.

16. An apparatus as defined in claim 11, wherein the prediction engine is to substitute one of the plurality of existing store locations for a candidate location to generate a prediction of the performance of the candidate location.

17. An apparatus as defined in claim 16, further comprising a difference analyzer to calculate a performance difference value between corresponding ones of the predicted performance of respective ones of the existing store locations and corresponding ones of empirical performance associated with the plurality of existing store locations.

18. An apparatus as defined in claim 17, further comprising a weight analyzer to solve the set of PCFs with calibration weights to minimize the difference values.

19. A tangible machine-readable storage medium comprising instructions stored thereon that, when executed, cause a machine to, at least:
generate a list of first descriptor types associated with a plurality of existing store locations;
calculate a set of analog principal components factors (PCFs) for corresponding ones of the plurality of existing store locations;
calculate a set of candidate PCFs for corresponding ones of a plurality of candidate locations;
calculate respective similarity values based on the PCFs associated with respective pairs of the plurality of existing store locations and the plurality of candidate locations;
for corresponding ones of the plurality of candidate locations, calculate a sum of second descriptor types associated with the existing store locations based on the respective similarity value; and
predict the performance of the candidate store locations based on a ratio of a sum of second descriptor types and a sum of the similarity values for the corresponding existing store location.

20. A machine readable storage medium as defined in claim 19, wherein the instructions, when executed, cause the machine to associate the plurality of existing store locations with the physical characteristics of the first descriptor types.

21. A machine readable storage medium as defined in claim 19, wherein the instructions, when executed, cause the machine to associate performance metrics of the second descriptor types with the plurality of existing store locations.

22. A machine readable storage medium as defined in claim 19, wherein the instructions, when executed, cause the machine to multiply the similarity values by respective performance metrics to generate weighted performance metrics.

23. A machine readable storage medium as defined in claim 19, wherein the instructions, when executed, cause the machine to substitute one of the plurality of existing store locations for a candidate location to generate a prediction of the performance of the candidate location.

24. A machine readable storage medium as defined in claim 23, wherein the instructions, when executed, cause the machine to calculate a performance difference value between corresponding ones of the predicted performance of respective ones of the existing store locations and corresponding ones of empirical performance associated with the plurality of existing store locations.

25. A machine readable storage medium as defined in claim 24, wherein the instructions, when executed, cause the machine to solve the set of PCFs with calibration weights to minimize the difference values.
